(19) United States
(12) Patent Application Publication
(10) Pub. No.: US 2023/0037426 A1
(43) Pub. Date: Feb. 9, 2023

(54) MOUTH COVER

(71) Applicant: ASICS Corporation, Kobe-shi (JP)

(72) Inventors: MAKOTO FUKUDA, Kobe-shi (JP); TSUYOSHI NISHIWAKI, Kobe-shi (JP); YOSUKE OTSUKA, Kobe-shi (JP); TAKEHIRO TAGAWA, Kobe-shi (JP); KENICHI HARANO, Kobe-shi (JP); JUN KONDO, Kobe-shi (JP); KOICHI MONMA, Kobe-shi (JP); MIZUHO IRIE, Kobe-shi (JP); KEI KANEMATSU, Kobe-shi (JP)

(21) Appl. No.: 17/971,413

(22) Filed: Oct. 21, 2022

Related U.S. Application Data
(63) Continuation of application No. PCT/JP2020/049268, filed on Dec. 28, 2020.

(30) Foreign Application Priority Data
Jul. 14, 2020 (JP) 2020-120745

(51) Int. Cl. A41D 13/11

(52) U.S. Cl. CPC A41D 13/113; A41D 13/1161

(57) ABSTRACT

A mouth cover includes a mouth cover body that covers at least the mouth and the nostrils of a wearer, and wearing portions that are connected to the mouth cover body and allow the wearer to wear the mouth cover body. The mouth cover body includes an opening in a downward direction from a position directly facing the mouth of the wearer.

### CROSS REFERENCE TO RELATED APPLICATIONS

This application is a continuation application of International Application No. PCT/JP2020/049268, filed on Dec. 28, 2020, which claims priority of Japanese (JP) Patent Application No. 2020-120745, filed on Jul. 14, 2020, the contents of which are hereby incorporated by reference in its entirety.

### BACKGROUND

### 1. Technical Field

The present disclosure relates to a mouth cover worn on a human face.

### 2. Description of Related Art

Recently, it has been recommended to wear a mask in daily life as a preventive measure against viral droplet-transmission diseases. It is recommended that such a mask be used by being worn such that the mask adheres to a wearer for the purpose of having the wearer being less likely to be affected with a disease and for the purpose of preventing droplets such as saliva expelled by the wearer from scattering when the wearer is affected, for instance (for example, refer to Japanese Patent No. 6356371).

Incidentally, such a mask is sometimes required to be worn even during exercise or work, for example, during outdoor running or at work in a factory. However, the mask described above is often adhered to the face of a wearer as much as possible. For this reason, there is a problem that it is difficult for a wearer to breathe during exercise or work while wearing a mask.

Hence, the present disclosure has been made in consideration of the foregoing problems, and an object thereof is to provide a mouth cover ensuring easiness of breathing while realizing curbing of diffusion of droplets by a wearer.

### SUMMARY

In order to resolve the foregoing problems, a mouth cover according to an aspect of the present disclosure includes a mouth cover body that covers at least the mouth and the nostrils of a wearer, and wearing portions that are connected to the mouth cover body and allow the wearer to wear the mouth cover body. The mouth cover body includes an opening in a downward direction from a position directly facing the mouth of the wearer.

The mouth cover according to the aspect of the present disclosure can provide more comfortable breathing than general masks in the related art to a wearer while covering the mouth and the nostrils of the wearer and curbing spattering of droplets of the wearer himself/herself toward other people by providing an opening on a lower side of the mouth cover.

### BRIEF DESCRIPTION OF THE DRAWINGS

FIG. 1A is a front view illustrating a form of use of a mouth cover according to Embodiment 1.

FIG. 1B is a side view illustrating a form of use of the mouth cover according to Embodiment 1.

FIG. 2A is a front view of the mouth cover according to Embodiment 1.

FIG. 2B is a side view of the mouth cover according to Embodiment 1.

FIG. 2C is a bottom view of the mouth cover according to Embodiment 1.

FIG. 3 is an exploded view of the mouth cover.

FIG. 4A is an unfolded front view of the mouth cover.

FIG. 4B is an unfolded rear view of the mouth cover.

FIG. 5A is a front view illustrating a form of use of a mouth cover according to Embodiment 2.

FIG. 5B is a side view illustrating a form of use of the mouth cover according to Embodiment 2.

FIG. 6A is a front view of the mouth cover according to Embodiment 2.

FIG. 6B is a side view of the mouth cover according to Embodiment 2.

FIG. 6C is a bottom view of the mouth cover according to Embodiment 2.

FIG. 7 is a schematic view schematically illustrating a method for manufacturing the mouth cover according to Embodiment 2.

FIGS. 8A to 8H are views illustrating different examples of an opening.

FIG. 9A is a view illustrating an example of a flow of air at the time of inhalation.

FIG. 9B is a view illustrating an example of a flow of air at the time of exhalation.

FIGS. 10A and 10B each are views illustrating an example in which a vent is provided in an opening.

FIG. 11A is a view illustrating a form in which cheek portions of the mouth cover on a rear surface side are patched.

FIG. 11B is a side view illustrating another form of the mouth cover.

FIG. 12A is a perspective view of the mouth cover illustrating a first example when a band-shaped member is used as a shape retention member.

FIG. 12B is a right side view of the mouth cover corresponding to that in FIG. 12A.

FIG. 13A is a perspective view of the mouth cover illustrating a second example when band-shaped members are used as shape retention members.

FIG. 13B is a right side view of the mouth cover corresponding to that in FIG. 13A.

FIG. 14A is a perspective view of the mouth cover illustrating a third example when band-shaped members are used as shape retention members.

FIG. 14B is a right side view of the mouth cover corresponding to that in FIG. 14A.

FIG. 15A is a perspective view of the mouth cover illustrating a fourth example when band-shaped members are used as shape retention members.

FIG. 15B is a right side view of the mouth cover corresponding to that in FIG. 15A.

FIG. 16A is a perspective view of the mouth cover illustrating a fifth example when band-shaped members are used as shape retention members.

FIG. 16B is a right side view of the mouth cover corresponding to that in FIG. 16A.

FIG. 17A is a perspective view of the mouth cover illustrating a sixth example when band-shaped members are used as shape retention members.

FIG. 17B is a right side view of the mouth cover corresponding to that in FIG. 17A.

FIG. 18A is a perspective view of the mouth cover illustrating a seventh example when band-shaped members are used as shape retention members.

FIG. 18B is a right side view of the mouth cover corresponding to that in FIG. 18A.

FIG. 19A is a perspective view of the mouth cover illustrating an eighth example when band-shaped members are used as shape retention members.

FIG. 19B is a right side view of the mouth cover corresponding to that in FIG. 19A.

FIG. 20A is a perspective view of the mouth cover illustrating a ninth example when band-shaped members are used as shape retention members.

FIG. 20B is a right side view of the mouth cover corresponding to that in FIG. 20A.

FIG. 21A is a perspective view of the mouth cover illustrating a tenth example when band-shaped members are used as shape retention members.

FIG. 21B is a right side view of the mouth cover corresponding to that in FIG. 21A.

FIG. 22A is a perspective view of the mouth cover illustrating an eleventh example when band-shaped members are used as shape retention members.

FIG. 22B is a right side view of the mouth cover corresponding to that in FIG. 22A.

FIG. 23A is a perspective view of the mouth cover when band-shaped members are used as shape retention members and the band-shaped members are respectively disposed on front and rear sides of a mouth cover body.

FIG. 23B is a right side view of the mouth cover corresponding to that in FIG. 23A.

FIG. 24A is a right side view illustrating an example of the mouth cover in a state in which the opening is open.

FIG. 24B is a right side view illustrating an example of the mouth cover in a state in which the opening is closed.

FIG. 25A is a right side view illustrating another example of the mouth cover in a state in which the opening is open.

FIG. 25B is a right side view illustrating another example of the mouth cover in a state in which the opening is closed.

FIGS. 26A and 26B are right side views illustrating an example of the mouth cover provided with deviation prevention members.

### DETAILED DESCRIPTION OF EMBODIMENTS

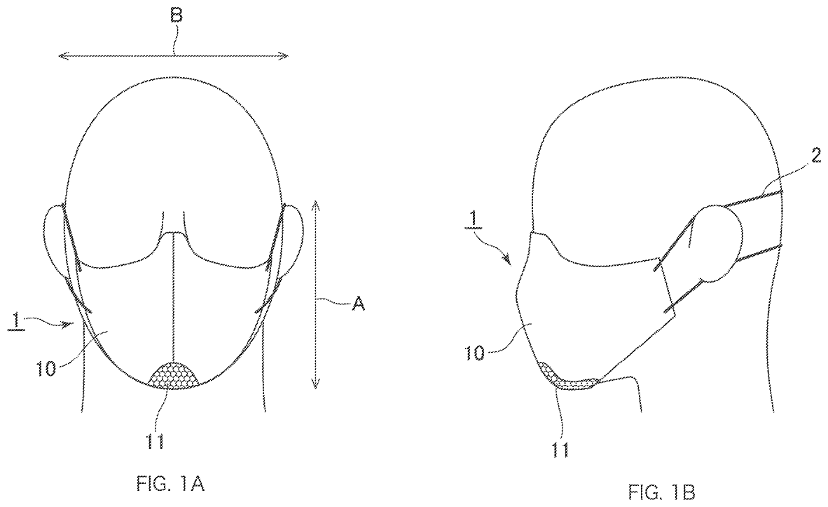

Hereinafter, a mouth cover according to embodiments of the present disclosure will be described in detail with reference to the drawings. Generally, the mouth cover according to the present disclosure may also be referred to as a mask. In addition, in the embodiments, a side where the mouth cover comes into contact with a wearer will be regarded as an inward side, and a side coming into contact with outside air will be regarded as an outward side. Further, a side close to the nose of the wearer when the wearer is wearing the mouth cover will be regarded as an upper portion, a side close to the chin will be regarded as a lower portion, a direction across the upper portion and the lower portion will be regarded as a vertical direction (refer to Arrow A in FIG. 1A), and a direction orthogonal to the vertical direction will be regarded as a lateral direction (refer to Arrow B in FIG. 1B).

### EMBODIMENT 1

### Constitution

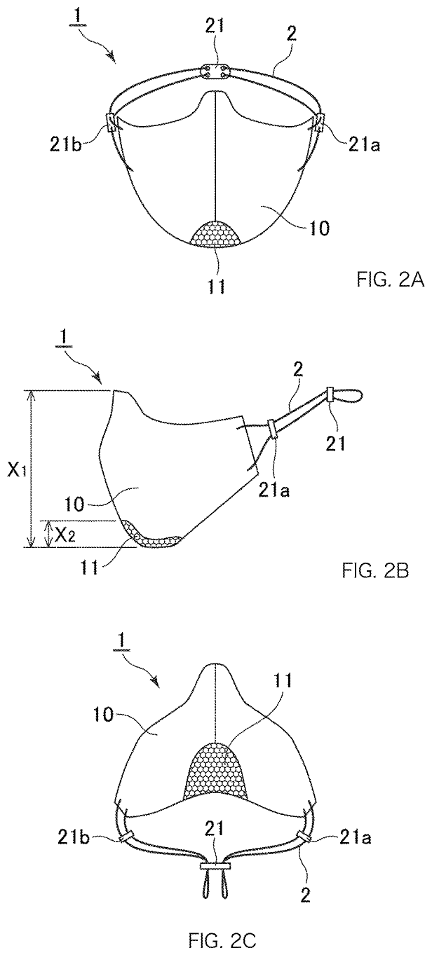

FIGS. 1A and 1B are views illustrating a form of use of a mouth cover 1 according to an aspect of the present disclosure. FIG. 1A is a front view when a wearer is wearing the mouth cover 1, and FIG. 1B is a side view when the wearer is wearing the mouth cover 1. In addition, FIG. 2A is a front view of the mouth cover 1, FIG. 2B is a right side view of the mouth cover 1, and FIG. 2C is a bottom view of the mouth cover 1.

As illustrated in FIGS. 1B and 2B, the mouth cover 1 includes a mouth cover body 10, and wearing portions 2 connected to the mouth cover body 10. As illustrated in FIGS. 1A and 1B, the mouth cover body 10 is formed to cover at least the mouth and the nostrils of the wearer, and it may be constituted to cover all the way down to portions below the cheeks and the chin. The mouth cover body 10 prevents droplets (exhalation (also referred to as outbreathing)) or the like coming out from the mouth or the nose of the wearer from spattering forward. In addition, the mouth cover body 10 may also function as a filter such that inhalation of a virus or the like in the air inhaled by the wearer is inhibited as much as possible.

The wearing portions 2 for fixing the mouth cover body 10 to the face of the wearer when the wearer is wearing it is connected to the mouth cover body 10. As an example, the wearing portions 2 are string-shaped objects. As an example, the wearing portions 2 may be formed of nylon or polyethylene. In the example of FIG. 1B, one end of each of the wearing portions 2 is connected to one end of the mouth cover body 10 in the lateral direction, and the wearing portions 2 are led around the occipital region and connected to the other end of the mouth cover body 10 in the lateral direction. Accordingly, the mouth cover body 10 is worn in a manner of adhering to the face of the wearer. Similar to general masks, the wearing portions 2 may be ear-hanging-type string members hung on the ears of the wearer. The string members may have flexibility. In that case, the mouth cover 1 can be easily worn on the face of the wearer. In addition, as illustrated in FIG. 2B, the wearing portions 2 may be provided with an adjustment member 21. The adjustment member 21 is a member allowing adjustment of the lengths of the string members and may also be referred to as a cord stopper, a cord adjuster, or the like. In FIG. 2B, the string member connected to the opposite side in the mouth cover body 10 is omitted. The wearing portions 2 may have a form in which holes are provided at end portions of the mouth cover body 10 such that the wearing portions 2 pass through the holes and are connected to the mouth cover body 10 or may have a form being connected thereto by bonding or stitching. The measurement between two holes which are provided at the end portions of the mouth cover body 10 and allow the wearing portions 2 to pass therethrough is preferably equal to or smaller than that connecting the upper and lower ends of the ears of a person having the standard physique stipulated by the Research Institute of Human Engineering for Quality Life (HQL), but it is not limited to this length. When the measurement between the two holes is set to be equal to or smaller than the measurement connecting the upper and lower ends of the ears of a person having the standard physique stipulated by the Research Institute of HQL, in-plane deformation of a shape retention member 14 is curbed, and therefore it is possible to provide the mouth cover 1 in which a gap is unlikely to be generated between the mouth cover body 10 and the wearer. The adjustment member 21 may be adjusted to be positioned near the occipital region of the wearer when the mouth cover 1 is worn, and the mouth cover 1 can be adhered to the face of the wearer by adjusting the lengths of the string members of the wearing portions 2. In addition, the wearing portions 2 may further include adjustment members 21a and 21b. The adjustment members 21a and 21b are members similar to the adjustment member 21. However, the position of the adjustment member 21a from the right end portion of the mouth cover body 10 (the left end portion when viewed from the wearer wearing it) can be adjusted, and the adjustment member 21b is a member of which the position from the left end portion of the mouth cover body 10 (the right end portion when viewed from the wearer wearing it) can be adjusted. The position of the adjustment member 21a may be adjusted such that it approaches the rear of the left ear of the wearer, and the position of the adjustment member 21b may be adjusted such that it approaches the rear of the right ear of the wearer. Due to this, the mouth cover 1 can be better adhered to the wearer. Due to the presence of the adjustment members 21, 21a, and 21b, the mouth cover 1 can be adhered to the face of the wearer, and therefore it is possible to reduce a likelihood that the mouth cover body 10 will deviate from the face of the wearer during exercise, working, or the like.

As illustrated in FIGS. 1A to 2C, the mouth cover body 10 includes an opening 11. As illustrated in the diagram, the opening 11 is provided in the lower portion of the mouth cover body 10. Specifically, the opening 11 is provided on a lower side of the mouth cover body 10 such that it is positioned below a position where the mouth of the wearer and the mouth cover body 10 directly face each other when the wearer is wearing the mouth cover 1. Here, a position directly facing the mouth of the wearer is a position where the mouth of the wearer and the mouth cover body 10 directly face each other when the wearer opens the mouth. Here, a wearer is assumed to be a human having the standard physique stipulated by the Research Institute of HQL, but it is not limited thereto. As an example, the opening 11 may be provided in the lower portion when the mouth cover body 10 is constituted of an upper portion covering the nose, a middle portion covering the mouth and the nostrils, and a lower portion covering the chin. More specifically, it may be provided within a range up to 30% from the lower end with respect to the overall height of the mouth cover body 10 when the mouth cover body 10 is folded (the state illustrated in FIG. 2B). That is, the ratio of a length X2 (the height allowed for the opening 11 from the lower end of the mouth cover body 10) to a length X1 (the overall height of the mouth cover body 10) illustrated in FIG. 2B may be 30% or less. Accordingly, droplets from the mouth of the wearer can be prevented from scattering in the forward direction from the wearer. In addition, since the opening 11 is provided in the mouth cover body 10, breathing of the wearer can be facilitated. Moreover, when a breath is expelled rearward by the wearer flow during running, arrival of the breath which has flowed out from the lower side of the mouth cover 1 to the height of the face of the following runner can be reduced. The opening 11 need only have a size to the extent that exhalation of the wearer can be expelled. As the area of the opening 11 becomes larger, it becomes easier for the wearer to breathe. On the other hand, a likelihood of diffusion of droplets or the like from the mouth of the wearer is improved. Meanwhile, as the area of the opening 11 becomes smaller, it becomes more difficult for the wearer to breathe, but a likelihood of diffusion of droplets decreases. Hence, when both effects of easiness of breathing of the wearer and an effect of preventing diffusion of droplets are expected, as an example, the area of the opening 11 may be set to approximately 5±1 cm². As a matter of course, when easiness of breathing is preferred, the area of the opening 11 may be set to be larger than this, and when improvement of the effect of preventing diffusion of droplets is desired, the area of the opening 11 may be set to be smaller than this. There is no need for the opening 11 to be limited to being at the illustrated position as long as it does not directly face the mouth of the wearer. In addition, there may be a plurality of openings 11. For example, the openings 11 may be formed in a form of being provided as slits at positions along left and right face lines of the wearer.

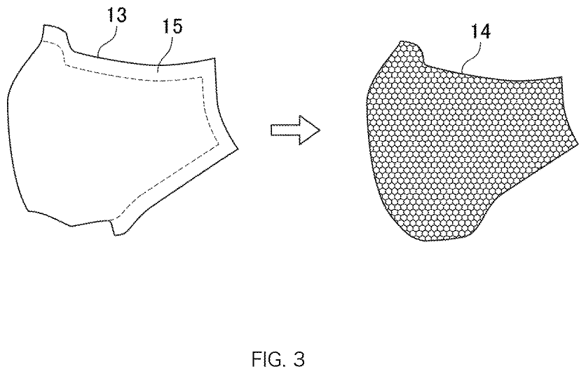

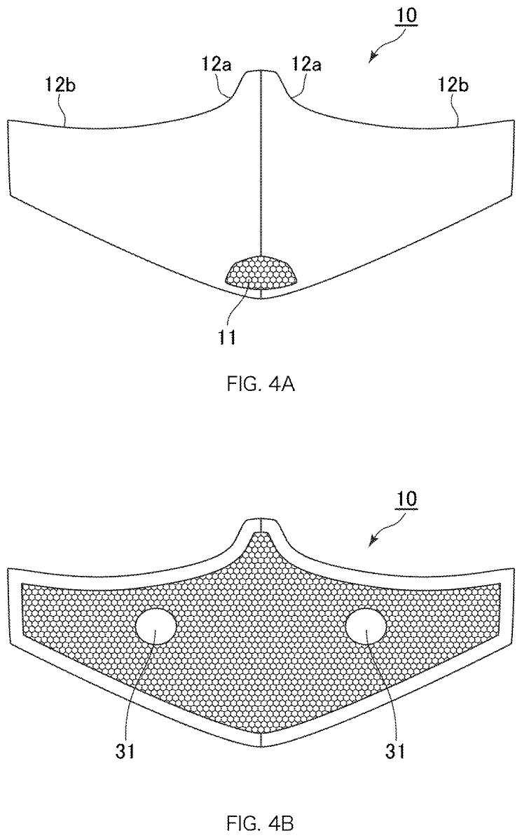

FIG. 3 is an explanatory view of a method for manufacturing the mouth cover body 10. FIG. 4A is a front view of the mouth cover body 10, and FIG. 4B is a rear view of the mouth cover body 10.

As illustrated in FIG. 3, the mouth cover body 10 is constituted to have a cloth 13 which has a wider area than the shape retention member 14 and overlaps the shape retention member 14.

The shape retention member 14 according to Embodiment 1 may be embodied using a thermoplastic resin such as polyethylene, polypropylene, nylon, or an acrylic resin, or a thermosetting resin. As an example, the shape retention member 14 may be embodied by forming a wire frame having a honeycomb structure with elastic threads using a thermoplastic polyester elastomer. The shape retention member 14 need only have a higher rigidity than the cloth 13 and may be a knitted fabric or a woven fabric of fibers. As an example, based on the stiffness conforming to the JIS cantilever method, the rigidity of the shape retention member 14 may be 150 mm or greater in the vertical direction (direction A in FIG. 1A), 150 mm or greater in the vertical direction on the rear side (wearer side), 90 mm or greater in a transverse direction (direction B in FIG. 1A), and 90 mm or greater in the transverse direction on the rear side (wearer side), but it is not limited thereto. When the wearer desires a softer mouth cover, the rigidity thereof may be below this, and when maintenance of the shape of the mouth cover is preferred, the rigidity thereof may be greater than this. The shape retention member 14 is a member capable of maintaining the mouth cover body 10 in a predetermined shape (the shape illustrated in FIGS. 1A, 1B, and the like).

The cloth 13 may be any cloth as long as it is a fabric capable of preventing diffusion of droplets which are likely to be expelled from the mouth of the wearer. However, as an example, it may be embodied using nylon, polyester, or an acrylic resin, in addition to a woven fabric, a non-woven fabric, or the like suitable therefor. The cloth 13 desirably has certain cushioning properties and desirably has a pleasant texture for the wearer.

The mouth cover body 10 is formed by causing the cloth 13 to overlap the entire front surface of the shape retention member 14 such that the shape retention member 14 is covered, wrapping around the shape retention member 14 with a surplus portion 15 of the cloth 13, and performing stitching. The cloth 13 and the shape retention member 14 may be formed of a plurality of members. That is, there is no need for the cloth 13 to be a piece of cloth. For example, it may be formed by stitching two pieces of cloth. Similarly, the shape retention member 14 may also be formed by joining or stitching a plurality of shape retention members.

As a result, it is possible to provide the mouth cover 1 having a pleasant texture by covering the entire front surface with the cloth 13 except for the opening 11 of the shape retention member 14, as illustrated in FIG. 4A, and placing the cloth 13 at a portion which comes into contact with the skin of the wearer in consequence of the end portion of the shape retention member 14 covered with the cloth 13, as illustrated in FIG. 4B. The diagrams illustrated in FIGS. 4A and 4B illustrate states in which the mouth cover body 10 is laterally unfolded, but the mouth cover body 10 is actually formed to have a three-dimensional shape covering the lower half portion of the face of the wearer. In addition, since the shape retention member 14 is constituted as a wire frame such that air can easily go in and out through a gap thereof, it becomes easy for the wearer to expel exhalation through the opening 11.

As illustrated in FIG. 4A, notches 12a and notches 12b may be formed in an upper end portion of the mouth cover body 10. Here, notches denote cutouts or recesses. That is, the upper end portion of the mouth cover body 10 has a recessed shape (curved shape) rather than being linearly constituted. The upper end portion of the mouth cover body 10 can have a discontinuous rigidity by providing the notches 12a and 12b. The notches 12a are provided at positions corresponding to both side portions of the bridge of the nose (nasofacial angle portions) of the wearer. In addition, the notches 12b are provided at positions corresponding to the cheek bone portions of the wearer. In ordinary masks, both sides of the bridge of the nose and the cheek bone portions are portions where a gap is likely to be generated due to the shapes thereof when worn by the wearer. Here, since notches are provided, the notch portions allow the mouth cover body 10 to have a structure which is likely to adhere to the skin of the wearer, and therefore leakage of exhalation of the wearer from the upper end portion of the mouth cover 1 can be curbed as much as possible. In addition, the notch portions may be covered with a highly flexible material. Since the notches 12a and 12b become portions with a high adhesion with respect to the wearer, contact with the wearer can be made soft by covering this portion with a highly flexible material, and therefore it is possible to reduce annoyance which may be caused due to the notch portions being adhered to the wearer at all times. Purposes of enhancing fitting feeling between the upper end portion of the mouth cover 1 and the wearer by providing the notches 12a and 12b include a purpose of preventing spectacles or sunglasses from fogging up due to leakage of outbreathing, and a purpose of causing outbreathing to flow downward. Outbreathing of the wearer is warmed and goes upward because the specific weight thereof is generally lighter than that of the ambient air. In contrast, if outbreathing is inhibited from coming out from the upper end portion of the mouth cover 1, outbreathing of the wearer can flow out toward the opening 11 on the lower side. Namely, the notches 12a and 12b are important structures for preventing a breath from leaking from the upper end portion of the mouth cover body 10 and guaranteeing outflow of outbreathing from the opening 11.

In addition, as illustrated in FIG. 4B, openings 31 may be provided in the shape retention member 14. Since the shape retention member 14 is not provided in the openings 31, air passes through these portions more easily than other portions, and therefore inhalation and exhalation of the wearer become more comfortable by the amount corresponding thereto.

### Conclusion of Embodiment 1

According to the mouth cover 1 described in Embodiment 1, since the mouth of the wearer directly faces the mouth cover body 10, droplets or the like coming out from the mouth of the wearer can be prevented from being emitted therearound (prevention of diffusion of droplets). In addition, in the mouth cover 1, due to the shape retention member 14 provided therein, the shape as the mouth cover is easily maintained, and since a space having a predetermined volume is formed around the mouth of the wearer, easiness of breathing can be embodied.

In addition, in the mouth cover body 10, since the opening 11 is provided below a position directly facing the mouth of the wearer, exhalation of the wearer expelled inside the mouth cover 1 can flow out through this opening 11. Therefore, breathing becomes easier with the mouth cover 1 than with masks in the related art (securing easiness of breathing). Therefore, according to the present Embodiment 1, it is possible to provide the mouth cover 1 realizing both prevention of diffusion of droplets and easiness of breathing.

In addition, since the notches 12a and 12b are provided in the upper end portion of the mouth cover body 10, it is possible to provide the mouth cover 1 that reduces a likelihood of generation of a gap which is likely to be generated in ordinary masks.

### EMBODIMENT 2

In the foregoing Embodiment 1, the mouth cover 1 that is made in a form in which the cloth 13 overlaps the shape retention member 14 constituted using a polyester-based elastomer has been described. In the present Embodiment 2, a mouth cover 1b embodied using a different material will be described.

### Constitution

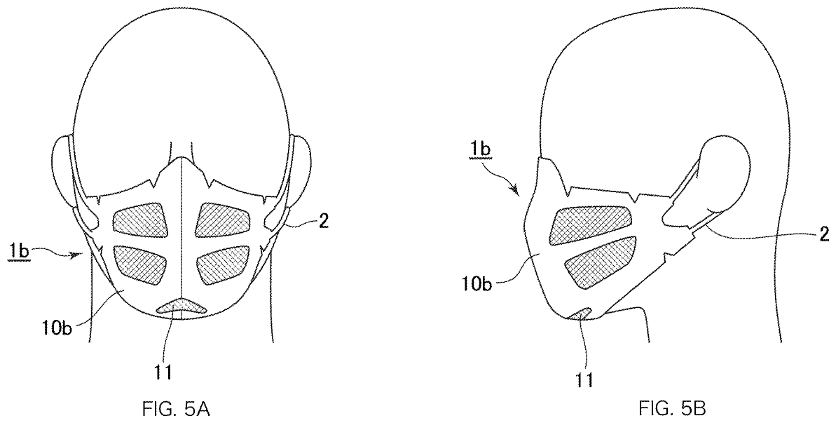

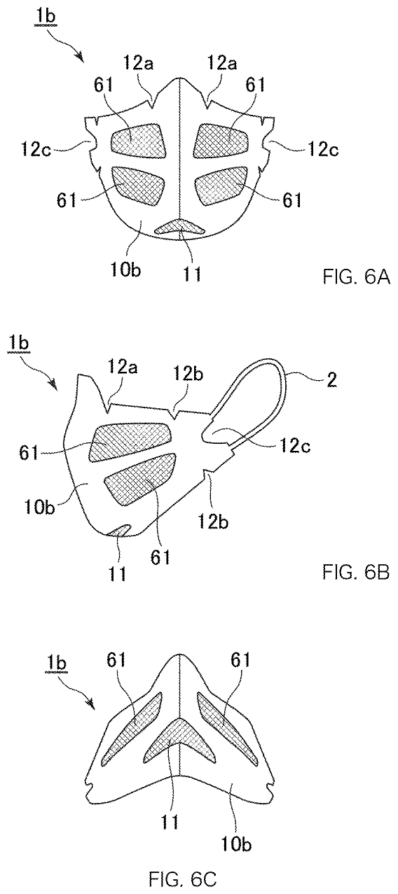

FIGS. 5A and 5B are views illustrating a form of use of the mouth cover 1b according to another aspect of the present disclosure. FIG. 5A is a front view when the wearer is wearing the mouth cover 1b, FIG. 5B is a side view when the wearer is wearing the mouth cover 1b. In addition, FIG. 6A is a front view of the mouth cover 1b, FIG. 6B is a right side view of the mouth cover 1b, and FIG. 6C is a bottom view of the mouth cover 1b. The shape of the mouth cover 1b is substantially similar to that of the mouth cover 1 described in Embodiment 1.

FIGS. 5A and 5B illustrate a form of use in which the mouth cover 1b is worn using the wearing portions 2 which allow the mouth cover 1b to be worn by being hung on the ears of the wearer. However, similar to Embodiment 1, this may be worn in a form in which the wearing portions 2 are led around the occipital region of the wearer.

As illustrated in FIGS. 6A, 6B, and 6C, a mouth cover body 10b is constituted of a frame formed of a non-woven fabric such as a recycled felt material, and a mesh fabric joined to windows 61 formed by cutting out the frame. Sticking, stitching, or other techniques may be used as a technique of joining the mesh fabric to the windows 61. In addition, a felt material for the frame portion may not be a reused material. Since the frame is manufactured from a recycled felt board and has a certain rigidity, it functions as a shape retention member. In the example illustrated in FIGS. 6A to 6C, an example in which four windows 61 are provided in total is described, but the number of windows 61 is not limited to four and may be two or six. The windows 61 may be provided anywhere in the mouth cover body 10 as long as the positions do not directly face the mouth of the wearer.

In the mouth cover body 10b, similar to Embodiment 1, notches may be provided. In the example illustrated in FIG. 6B, in the mouth cover body 10b, the notches 12a and the notches 12b are provided in the upper end portion thereof, notches 12c are provided at the end portions of the mouth cover body 10b in the lateral direction, and notches 12d are provided in the lower end portion. That is, the notches are provided on both sides of the bridge of the nose of the wearer (nasofacial angle portions), and at positions corresponding to the mouth cover body 10b around the cheek bones of the lower portions of the outer corners of the eyes of the wearer. In ordinary masks, these positions are positions where a gap is likely to be generated between the mask and the wearer when it is worn. Therefore, it is favorable that the notches be formed at positions where a gap is likely to be generated between the mask and the wearer when the wearer is wearing a general disposable mask which is pressed and molded into a rectangular shape.

The notches illustrated in FIGS. 6A to 6C are clearly constituted as cutouts. However, in a case of having this shape, since there is a likelihood that they will come into contact with the skin of the wearer and cause a pain, rounding processing may be performed. As a result, the notches may be formed as curved recesses as described in Embodiment 1.

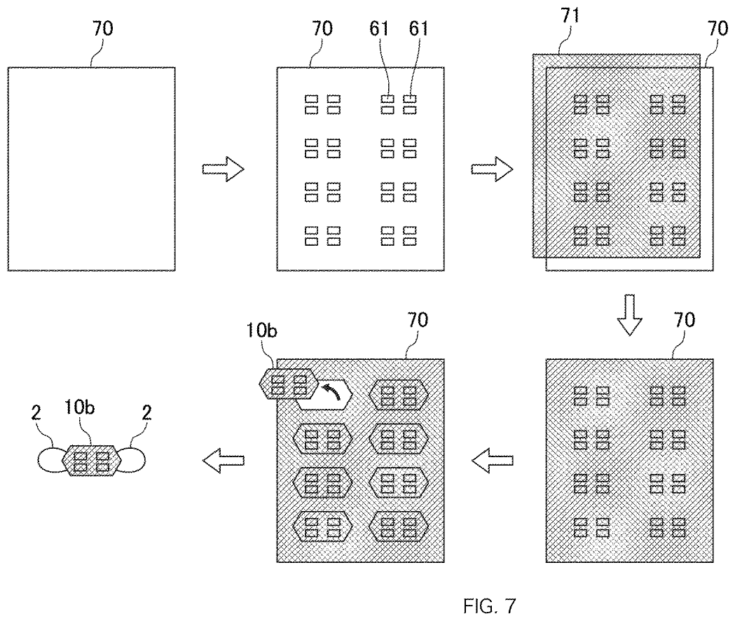

FIG. 7 is a schematic view schematically illustrating a method for manufacturing the mouth cover 1b according to Embodiment 2. An example of a method for manufacturing the mouth cover 1b will be described using FIG. 7.

First, as illustrated on the left in the upper stage in FIG. 7, a felt board (compressive rigid cloth) 70 made of recycled felt is prepared. Next, as illustrated in the middle of the upper stage in FIG. 7, a plurality of windows 61 are cut out from the felt board 70. Further, as illustrated on the right in the upper stage in FIG. 7, a mesh fabric 71 is prepared and caused to overlap the felt board 70. The felt board 70 is not limited to a compressive rigid cloth as long as it is a cloth having a rigidity to the extent that shape retaining properties can be maintained.

Next, as illustrated on the right in the lower stage in FIG. 7, the overlapped mesh fabric 71 is subjected to thermocompression bonding (heat sealing) with respect to the felt board 70 in which the plurality of windows 61 are formed. This thermocompression bonding treatment is an example, and sticking simply using a bonding agent may be performed or sewing may be performed. Next, as illustrated in the middle of the lower stage in FIG. 7, cutting is performed with a mold for the mouth cover body 10b, and the mouth cover body 10b is cut out from the felt board 70. Further, as illustrated on the left in the lower stage in FIG. 7, the mouth cover 1b is formed by sewing the wearing portions 2 to be hung on the ears on the cut-out mouth cover body 10b. The mouth cover 1b may be manufactured in this manner. In FIG. 7, the shapes of the mouth cover 1b and the windows 61 are illustrated in a simplified manner. In addition, in the case of the manufacturing method illustrated in FIG. 7, the mesh fabric is also joined to the opening 11 as illustrated in FIGS. 5A, 5B, and the like. However, the mesh fabric over the opening 11 may be removed for complete openings.

### Conclusion of Embodiment 2

According to the mouth cover 1b in Embodiment 2, similar to Embodiment 1, not only prevention of diffusion of droplets and securing of easiness of breathing can be embodied but also the mouth cover body 10b is embodied using a recycled felt, and therefore it is possible to provide the environment-friendly mouth cover 1b. In addition, as illustrated in FIG. 7, the mouth cover 1b is also excellent in mass productivity.

### EMBODIMENT 3

In the foregoing Embodiment 1, the shape retention member 14 is embodied using a thermoplastic resin such as polyethylene, polypropylene, or an acrylic resin, or a thermosetting resin. An example in which the shape retention member 14 is embodied by forming a wire frame having a honeycomb structure with elastic threads using a thermoplastic polyester elastomer has been described as an example. In addition, in the foregoing Embodiment 2, the mouth cover 1b formed of a recycled felt and functioning as a shape retention member is described.

In the present Embodiment 3, being different from the foregoing Embodiments 1 and 2, in order to maintain the shape of the mouth cover 1, a constitution in which the shape of the mouth cover 1 is easily maintained when the wearer is wearing the mouth cover 1 using a member having a band shape extending in at least any one direction of upward, downward, leftward, rightward, and oblique directions in a case in which the mouth cover 1 is put in a manner of having a planar shape will be described. Here, a member having a band shape may be embodied using a material similar to that of the shape retention member described in the foregoing Embodiments 1 and 2 or may be embodied using other materials. However, here, a resin wire is used as a band-shaped member.

As a shape retention member, a band-shaped member 24 is constituted for the purpose of retaining the shape thereof when the wearer is wearing the mouth cover 1 and retaining a space between the wearer and the mouth cover 1. In other words, the rigidity and the elasticity of the mouth cover 1 need only be improved compared to a state in which no band-shaped member is provided. Therefore, the band-shaped member may be constituted of the same material as that of the mouth cover body 10, and the rigidity may be enhanced by stitching a portion at the position where a band-shaped member is provided as described below. In addition, the width of the band-shaped member may be any width as long as the rigidity and the elasticity of the mouth cover 1 can be improved. As an example, it may be 5 to 15 mm. In addition, the band-shaped member 24 may be attached to the mouth cover 1 by sewing or may be attached thereto by bonding.

### Pattern 1

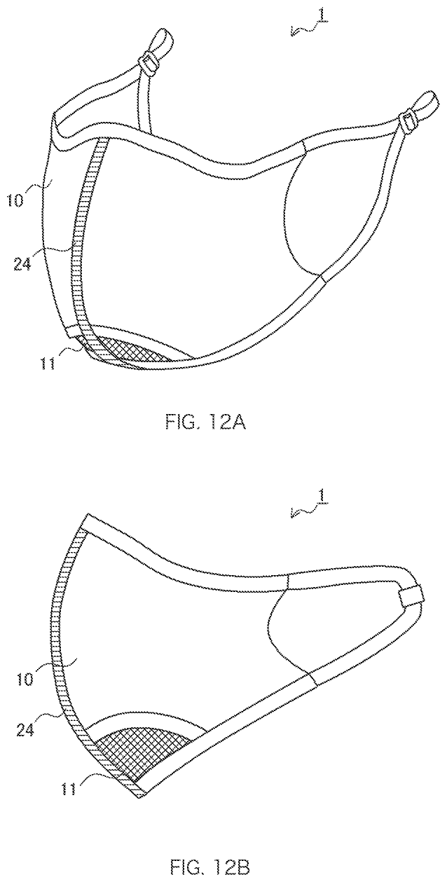

FIG. 12A is a perspective view illustrating an example of the mouth cover 1 provided with the band-shaped member 24 as a shape retention member. In addition, FIG. 12B is a right side view of the mouth cover 1 corresponding to that in FIG. 12A.

As illustrated in the diagram, in the mouth cover 1 illustrated in FIG. 12A, the band-shaped member 24 is provided from an upper end to a lower end of the mouth cover body 10, that is, from a position abutting a portion in the vicinity of the base of the nose of the wearer to a position abutting a portion in the vicinity of the chin of the wearer when worn by the wearer. The illustrated example literally illustrates an example in which the band-shaped member 24 extends vertically in a manner of passing through the center of the mouth cover 1. Since the band-shaped member 24 is provided so as to be positioned at the center of the mouth cover 1, compared to a case in which no band-shaped member 24 is provided, the rigidity and the elasticity of the mouth cover 1 can be improved. In the example illustrated in FIGS. 12A and 12B, the band-shaped member 24 is provided in the mouth cover body 10 so as to suspend, that is, straddle the opening 11.

### Pattern 2

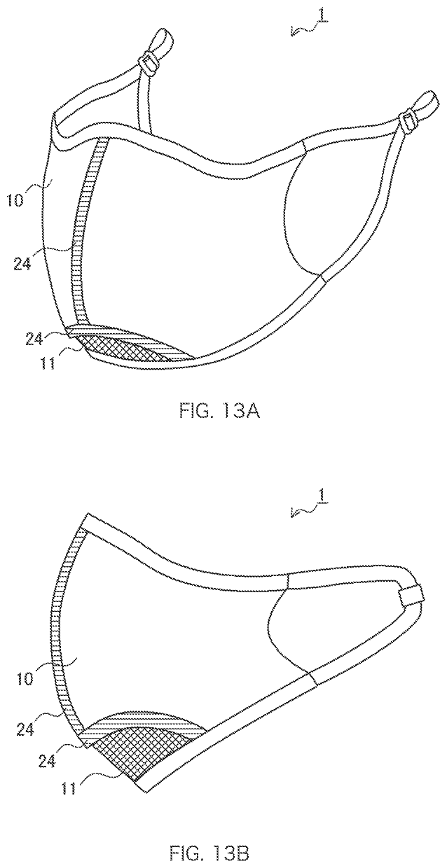

FIG. 13A is a perspective view illustrating an example of the mouth cover 1 provided with the band-shaped members 24 as shape retention members. In addition, FIG. 13B is a right side view of the mouth cover 1 corresponding to that in FIG. 13A.

As illustrated in the diagram, in the mouth cover 1 illustrated in FIG. 13A, the band-shaped member 24 is provided such that it vertically extends from the upper end of the mouth cover 1 to the upper end of the opening 11. In the example illustrated in FIGS. 13A and 13B, being different from the example illustrated in FIGS. 12A and 12B, the band-shaped member 24 does not suspend the opening 11. In addition, in order to improve the strength of the lower end portion of the band-shaped member 24 extending to the upper limit, as illustrated in FIGS. 13A and 13B, another band-shaped member 24 is also provided at an edge of the opening 11 which is an upper end edge of the opening 11. That is, it is possible to mention that the band-shaped member 24 provided at the upper end edge of the opening 11 extends in the lateral direction of the mouth cover 1. The band-shaped members 24 may be provided in the mouth cover body 10 in such a form. In the example illustrated in FIGS. 13A and 13B, the rigidity and the elasticity of the mouth cover 1 can be further improved than those in the example illustrated in FIGS. 12A and 12B.

### Pattern 3

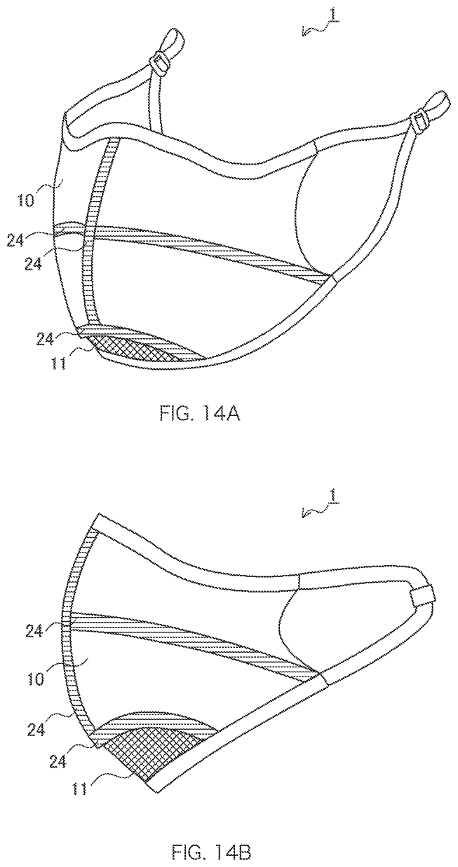

FIG. 14A is a perspective view illustrating an example of the mouth cover 1 provided with the band-shaped members 24 as shape retention members. In addition, FIG. 14B is a right side view of the mouth cover 1 corresponding to that in FIG. 14A.

As illustrated in the diagram, in the mouth cover 1 illustrated in FIG. 14A, in addition to those of the mouth cover 1 illustrated in FIGS. 13A and 13B, another band-shaped member 24 extending in the lateral direction in a manner of passing through the center in the vertical direction of the mouth cover body 10 is provided. There is no need for the center in the vertical direction mentioned herein to be strictly the center, and the band-shaped member 24 need only be attached to the mouth cover body 10 in a manner of passing through a portion in the vicinity of the apex of the nose of the wearer when the wearer is wearing the mouth cover 1. In addition, the end portions of the band-shaped member 24 on the outward sides may be constituted to pass through attachment portions of the wearing portions on the lower side. Due to this constitution, even when the wearing portions are pulled rearward, the shape of the mask body is likely to be retained (it is possible to stand against pulling forces applied to the wearing portions). In the mouth cover 1 illustrated in FIGS. 14A and 14B, compared to the mouth cover 1 illustrated in FIGS. 13A and 13B, since the band-shaped member 24 extending in the lateral direction is provided, it becomes a mouth cover having higher rigidity and elasticity.

### Pattern 4

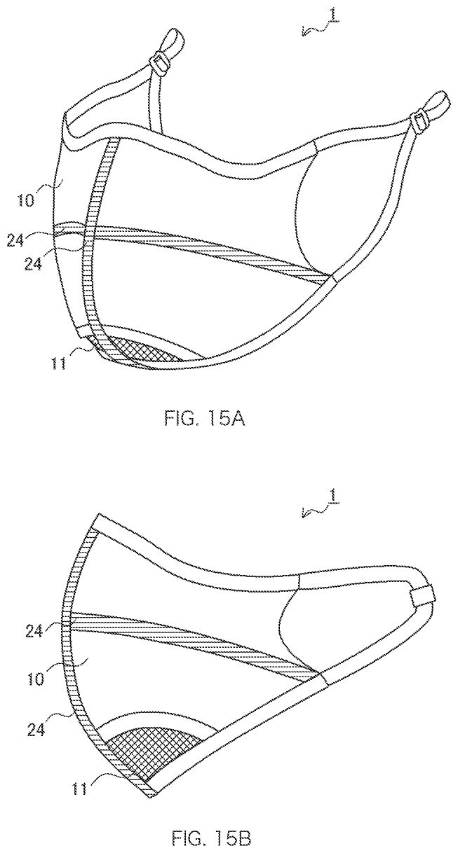

FIG. 15A is a perspective view illustrating an example of the mouth cover 1 provided with the band-shaped members 24 as shape retention members. In addition, FIG. 15B is a right side view of the mouth cover 1 corresponding to that in FIG. 15A.

As illustrated in the diagram, compared to the mouth cover 1 illustrated in FIGS. 12A and 12B, similar to FIGS. 14A and 14B, the mouth cover 1 illustrated in FIGS. 15A and 15B includes the band-shaped member 24 which passes through the center in the vertical direction of the mouth cover body 10 and laterally extends. In the mouth cover 1 illustrated in FIGS. 15A and 15B, compared to the mouth cover 1 illustrated in FIGS. 12A and 12B, the rigidity and the elasticity thereof are further improved by the amount of the band-shaped member 24 which laterally extends.

### Pattern 5

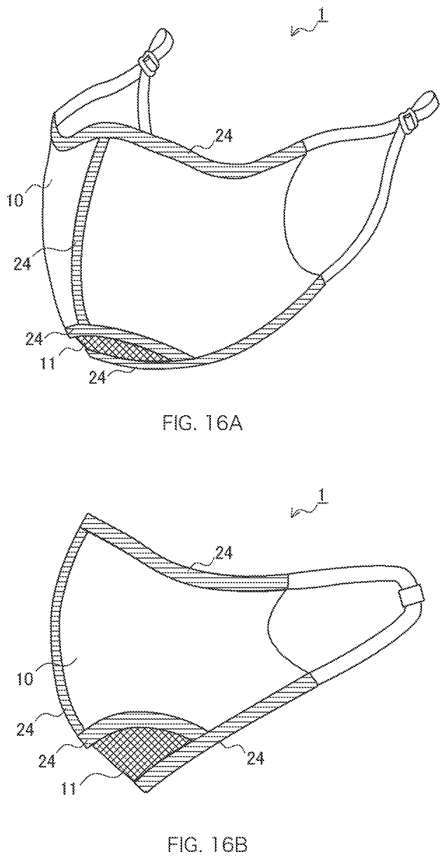

FIG. 16A is a perspective view illustrating an example of the mouth cover 1 provided with the band-shaped members 24 as shape retention members. In addition, FIG. 16B is a right side view of the mouth cover 1 corresponding to that in FIG. 16A.

As illustrated in the diagram, compared to the mouth cover 1 illustrated in FIGS. 13A and 13B, the mouth cover 1 illustrated in FIGS. 16A and 16B further includes the band-shaped members 24 at the upper end edge and the lower end edge of the mouth cover body 10. As illustrated in FIGS. 16A and 16B, since the band-shaped member 24 is provided at the upper end edge or the lower end edge of the mouth cover body 10, the shape of the mouth cover 1 is easily maintained, and fitting feeling of the mouth cover 1 in the upper end portion or the lower end portion of the mouth cover 1 with respect to the wearer can be improved.

### Pattern 6

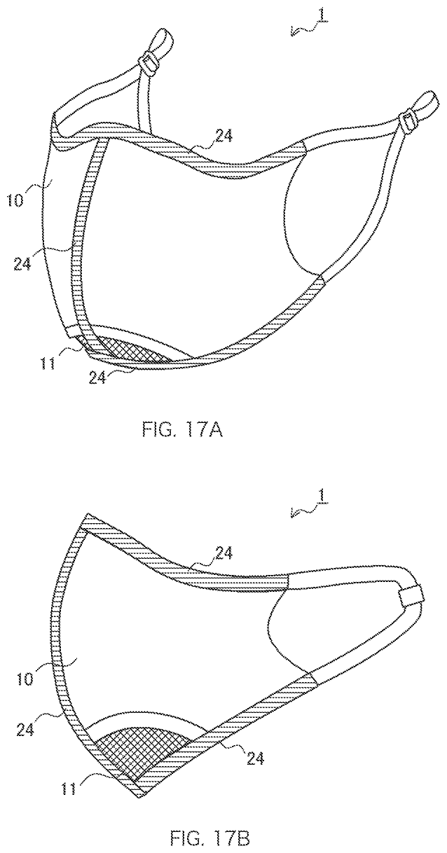

FIG. 17A is a perspective view illustrating an example of the mouth cover 1 provided with the band-shaped members 24 as shape retention members. In addition, FIG. 17B is a right side view of the mouth cover 1 corresponding to that in FIG. 17A.

As illustrated in the diagram, compared to the mouth cover 1 illustrated in FIGS. 12A and 12B, similar to FIGS. 16A and 16B, the mouth cover 1 illustrated in FIGS. 17A and 17B includes the band-shaped members 24 at the upper end edge and the lower end edge of the mouth cover body 10. In the mouth cover 1 illustrated in FIGS. 17A and 17B, compared to the mouth cover 1 illustrated in FIGS. 12A and 12B, it is possible to expect that the mouth cover 1 will have higher rigidity and elasticity by the amount of the band-shaped members 24 provided at the upper end edge and the lower end edge.

### Pattern 7

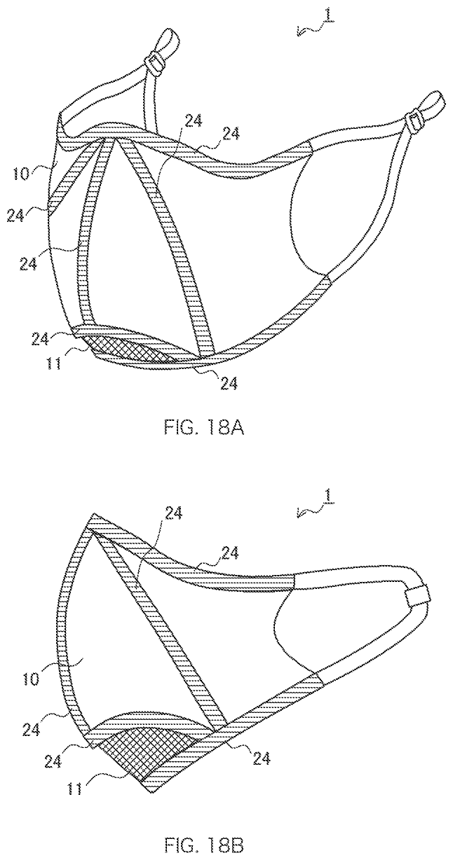

FIG. 18A is a perspective view illustrating an example of the mouth cover 1 provided with the band-shaped members 24 as shape retention members. In addition, FIG. 18B is a right side view of the mouth cover 1 corresponding to that in FIG. 18A.

As illustrated in the diagram, in the mouth cover 1 illustrated in FIGS. 18A and 18B, compared to the mouth cover 1 illustrated in FIGS. 16A and 16B, the band-shaped members 24 extending in oblique directions are further provided. At this time, the band-shaped members 24 are provided from the upper end portion of the mouth cover body 10 abutting a portion in the vicinity of the base of the nose of the wearer to the lower end portion of the mouth cover body 10 in a manner of passing through portions in the vicinity of the alae of the nose of the wearer. Accordingly, compared to the mouth cover 1 illustrated in FIGS. 16A and 16B, the mouth cover 1 illustrated in FIGS. 18A and 18B has higher rigidity and elasticity. In addition, it is possible to provide the mouth cover 1 having higher rigidity and elasticity by further adding the band-shaped members 24 extending not only in the vertical direction and the lateral direction but also in the oblique directions.

### Pattern 8

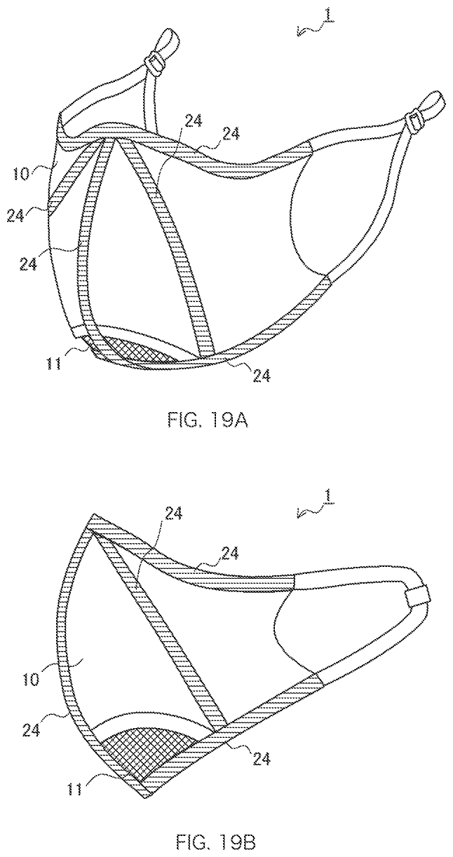

FIG. 19A is a perspective view illustrating an example of the mouth cover 1 provided with the band-shaped members 24 as shape retention members. In addition, FIG. 19B is a right side view of the mouth cover 1 corresponding to that in FIG. 19A.

As illustrated in the diagram, compared to the mouth cover 1 illustrated in FIGS. 17A and 17B, similar to the mouth cover 1 illustrated in FIGS. 18A and 18B, the mouth cover 1 illustrated in FIGS. 19A and 19B includes the band-shaped members 24 extending in the oblique directions. Since the mouth cover 1 illustrated in FIGS. 19A and 19B includes the band-shaped member 24 extending in the oblique directions, it has higher rigidity and elasticity than the mouth cover 1 illustrated in FIGS. 17A and 17B.

### Pattern 9

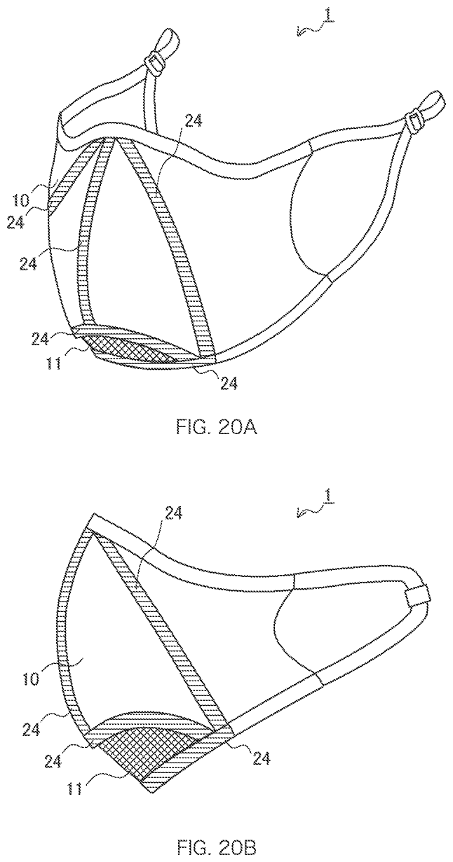

FIG. 20A is a perspective view illustrating an example of the mouth cover 1 provided with the band-shaped members 24 as shape retention members. In addition, FIG. 20B is a right side view of the mouth cover 1 corresponding to that in FIG. 20A.

As illustrated in the diagram, compared to the mouth cover 1 illustrated in FIGS. 13A and 13B, the mouth cover 1 illustrated in FIGS. 20A and 20B has a constitution further including the band-shaped members 24 extending in the oblique directions. In addition, in the mouth cover 1 illustrated in FIGS. 20A and 20B, the band-shaped member 24 is also provided at the entire edge of the opening 11. Accordingly, it is possible to provide the mouth cover 1 having higher rigidity and elasticity than the mouth cover 1 illustrated in FIGS. 13A and 13B.

### Pattern 10

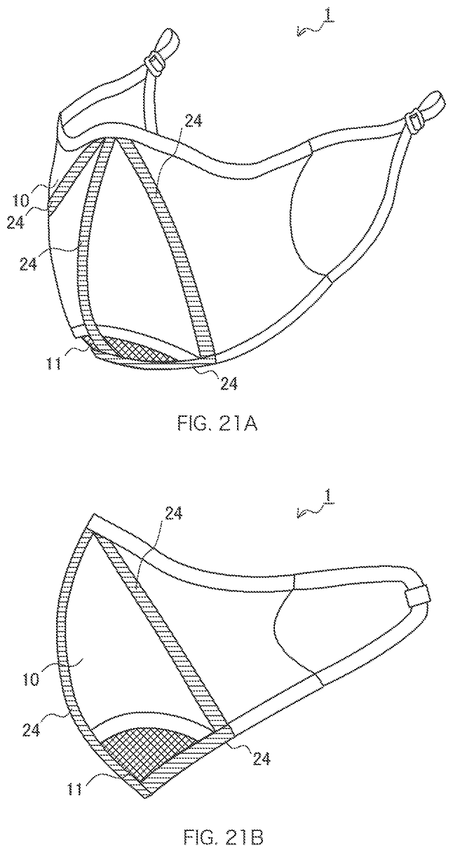

FIG. 21A is a perspective view illustrating an example of the mouth cover 1 provided with the band-shaped members 24 as shape retention members. In addition, FIG. 21B is a right side view of the mouth cover 1 corresponding to that in FIG. 21A.

As illustrated in the diagram, the mouth cover 1 illustrated in FIGS. 20A and 20B is a mouth cover 1 in which the band-shaped members 24, which have merely extended in the vertical direction from the upper end of the mouth cover 1 to the upper end of the opening 11 in the mouth cover 1 illustrated in FIGS. 21A and 21B, is constituted to suspend the opening 11. Due to such a constitution as well, it is possible to provide the mouth cover 1 having high rigidity and elasticity, particularly the mouth cover 1 which is likely to secure spaces around the nose and the mouth of the wearer.

### Pattern 11

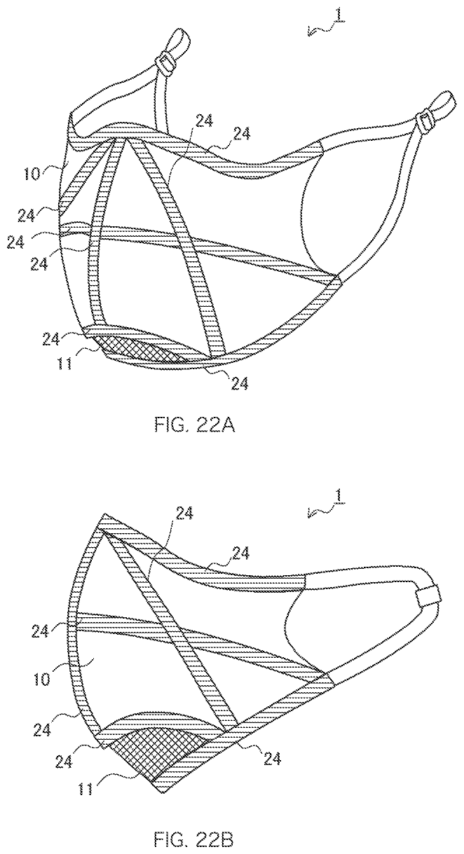

FIG. 22A is a perspective view illustrating an example of the mouth cover 1 provided with the band-shaped members 24 as shape retention members. In addition, FIG. 22B is a right side view of the mouth cover 1 corresponding to that in FIG. 22A.

As illustrated in the diagram, compared to the mouth cover 1 illustrated in FIGS. 18A and 18B, the mouth cover 1 illustrated in FIGS. 22A and 22B illustrates an example further provided with the band-shaped member 24 extending in the lateral direction in a manner of passing through the center of the mouth cover body 10 in the vertical direction. In this manner, it is possible to constitute the mouth cover 1 having higher rigidity and elasticity by providing more band-shaped members 24.

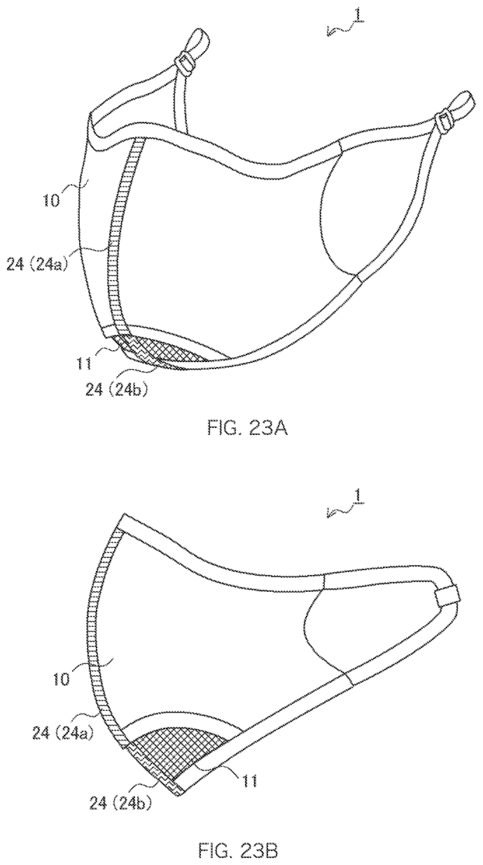

Examples for improving shape retaining properties of the mouth cover 1 by means of the band-shaped members 24 have been described using the foregoing (Pattern 1) to (Pattern 11), but a method for providing the band-shaped members 24 is not limited thereto. In addition, as illustrated in the diagram, the band-shaped members 24 may be provided in an outer fabric of the mouth cover body 10 or may be provided in a lining fabric. In addition, the band-shaped members 24 may be provided on both surfaces of the mouth cover body 10. In addition, when the band-shaped members 24 are provided in both the outer fabric and the lining fabric of the mouth cover body 10, the lengths thereof may be different lengths. That is, as illustrated in FIGS. 23A and 23B, the band-shaped member 24 (24a) provided in the outer fabric may have a length from the upper end of the mouth cover body 10 to the lower end (the upper end of the opening), and the band-shaped member 24 (24b) provided in the lining fabric may have a length from the upper end of the mouth cover body 10 to the lower end of the opening 11. Regarding the lengths of the band-shaped members, in the example of FIGS. 23A and 23B, an example in which the band-shaped member 24a provided on the front side is shorter than the band-shaped member 24b provided on the rear side is described, but this may be reversed. However, the form illustrated in FIGS. 23A and 23B exhibits higher shape retaining properties of the mouth cover 1.

In addition, if the ratio of the band-shaped member 24 to the mouth cover 1 is increased, the shape retaining properties are improved by the amount thereof. On the other hand, the production costs increase by the amount thereof. For this reason, there is a trade-off relationship between the amount of the band-shaped member 24 provided in the mouth cover 1 and the production costs.

### Conclusion of Embodiment 3

According to the mouth cover 1 in Embodiment 3, it is possible to embody improvement of shape retaining properties (rigidity and elasticity) of the mouth cover 1 while having fewer members (having a small area ratio) compared to the foregoing Embodiments 1 and 2, by using the band-shaped members 24 that are members having a band shape as shape retention members. In addition, as illustrated from FIGS. 12A to 22B, the rigidity and the elasticity of the mouth cover 1 can be ensured simply with fewer band-shaped members 24 by providing band-shaped members 24 functioning as shape retention members at places which are important locations in the mouth cover 1.

### SUPPLEMENTATION

Needless to say, the mouth covers according to the foregoing embodiments are not limited to the foregoing embodiments and may be embodied by other techniques. Hereinafter, various modification examples will be described.

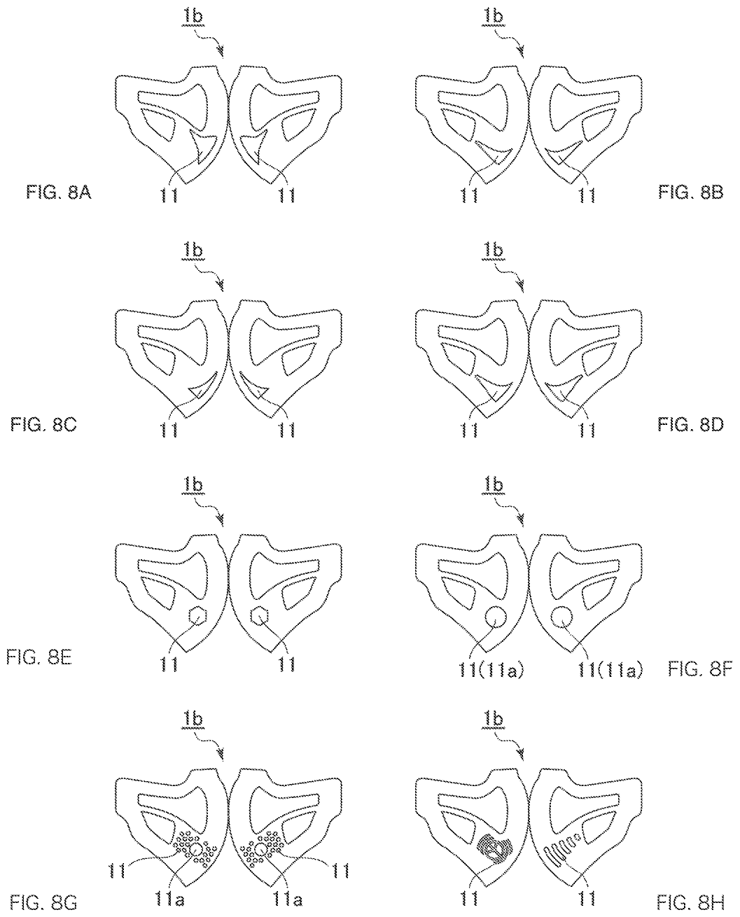

(1) The shapes of the opening 11 illustrated in the foregoing Embodiments 1 and 2 are merely examples. The shape of the opening 11 is not limited to the shapes described in the foregoing Embodiments 1 and 2, and the opening 11 may be embodied in various shapes as long as droplets or the like coming out from the mouth of the wearer are not emitted. FIGS. 8A to 8H illustrate other examples of the shape which may be adopted for the opening 11. FIGS. 8A to 8H illustrate the mouth cover body 10b described in Embodiment 2. However, it is also the same in Embodiment 1 that the opening 11 may have various shapes. In FIGS. 8A to 8H, the mouth cover 1b is illustrated in a shape divided into the left and right sides, but the left and right openings 11 may become one opening when the mouth cover 1b is formed. This opening 11 may be utilized as a straw insertion portion 11a for inserting a member such as a straw for ingesting a beverage. That is, as illustrated in FIG. 8F, when the opening 11 has a sufficient extent for inserting a straw, the wearer can drink a beverage without detaching and shifting the mouth cover 1 during exercise or work. In addition, when a plurality of openings 11 are provided as illustrated in FIG. 8G, among the openings 11, an opening 11 having a sufficient extent for inserting a straw may be utilized as the straw insertion portion 11a. Although the reference sign 11a is not applied to FIGS. 8A to 8E, the opening 11 may be utilized as a straw insertion portion.

In addition, as illustrated in FIGS. 8G and 8H, the opening 11 may be embodied by a plurality of openings. In that case, the sizes of the openings may be varied. In addition, it is possible to provide the mouth covers 1 and 1b which are superior in appearance and design to those simply provided with an opening by having such shapes as in FIGS. 8G and 8H.

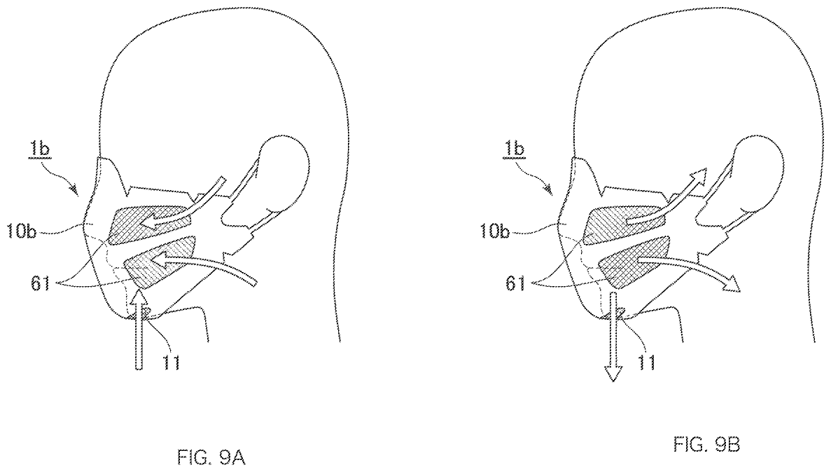

(2) A flow of air of inhalation and exhalation in the foregoing Embodiments 1 and 2 will be described herein in detail. FIG. 9A is a schematic view schematically illustrating a flow of air at the time of inhalation of the wearer. In addition, FIG. 9B is a schematic view schematically illustrating a flow of air at the time of exhalation of the wearer. FIGS. 9A and 9B illustrate an example in which the mouth cover 1b described in Embodiment 2 is worn, but a basic flow of air is also the same in Embodiment 1.

As illustrated in FIG. 9A, at the time of inhalation, the wearer can inhale the air via the opening 11 and the windows 61. Although a mesh fabric is joined to the windows 61, air flows in due to high air permeability of the mesh fabric.

Meanwhile, as illustrated in FIG. 9B, at the time of exhalation, exhalation of the wearer is expelled downward with respect to the face of the wearer via the opening 11. That is, even if some droplets are expelled from the mouth or the like of the wearer together with exhalation, they do not diffuse in the forward direction of the wearer. In addition, due to the presence of the opening 11, exhalation of the wearer is smoothly discharged compared to a case of having no opening 11, and therefore breathing of the wearer can be facilitated.

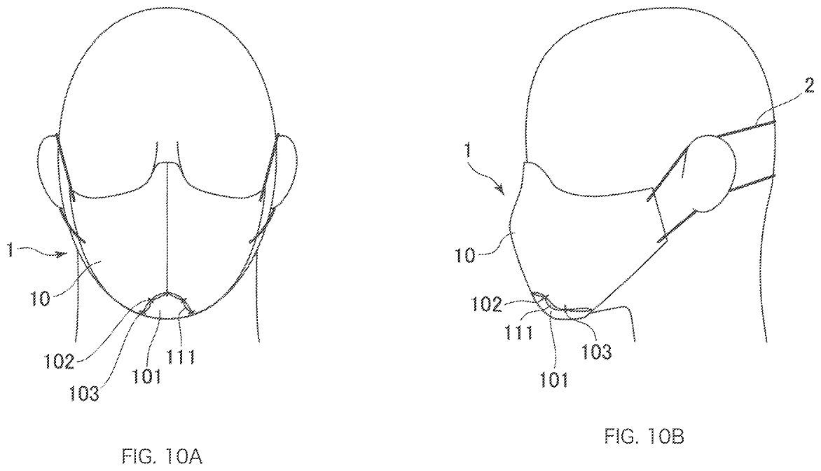

(3) Although it is not particularly described in the foregoing Embodiments 1 and 2, a vent may be provided in the opening 11. The vent mentioned herein denotes a mechanism for allowing a flow of air in one direction and inhibiting a flow of air in multi-directions. FIGS. 10A and 10B illustrate an example in which a vent 101 is provided in the opening 11. As an example, the vent 101 may be embodied using a thin fabric. In the vent 101, only a portion of the end portion thereof is sewed and connected thereto around the opening 11 of the mouth cover body 10. Therefore, there is a gap 111 between the vent 101 and the mouth cover 1. When the mouth cover 1 has this constitution, outside air tends to flow in via the gap 111 at the time of inhalation of the wearer. As a result, the vent 101 in its entirety is pressed against the opening 11, thereby filling the gap 111. Meanwhile, at the time of exhalation of the wearer, it can have a constitution in which exhalation is discharged from the inside of the mouth cover body 10 through the gap 111 between the opening 11 and the vent 101.

In addition, such a vent may be provided on the inward side (wearer side) of the windows 61 in the foregoing Embodiment 2. In this case, it is possible to embody a structure in which inflow of air from the windows 61 is allowed at the time of inhalation and outflow from the windows 61 is curbed at the time of exhalation. Therefore, dust resistance to a certain extent can be ensured by going through the mesh fabric of the windows 61 at the time of inhalation, and prompt exhalation to the opening 11 can be embodied at the time of exhalation (a flow of air generated due to exhalation is made uniform).

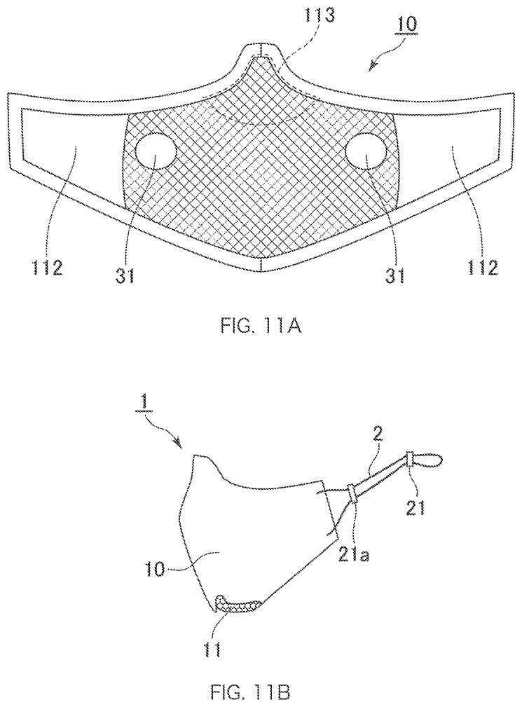

(4) In the foregoing Embodiment 1, a patch may be provided on the rear surface side of the mouth cover body 10 in a location having a likelihood of touching the cheeks of the wearer. That is, the mouth cover 1 may have a constitution in which the shape retention member 14 does not directly touch the cheeks of the wearer. That is, as illustrated in FIG. 11A, a patch 112 may be provided in a location having a likelihood of touching the cheeks of the wearer on the rear surface side of the mouth cover body 10b. This patch 112 may be embodied using the same material as that of the cloth 13 and may be integrally molded with the cloth 13. Due to such a constitution, a likelihood that the shape retention member 14 will directly touch the cheeks of the wearer can be reduced, and the sense of use of the mouth cover 1 can be improved. In addition, regarding the patch 112, a material which can impart cool feeling (a cool contact material such as polyethylene, linen, or a fabric utilizing a metal, for example) or a hygroscopic material (for example, a combination of nylon and polyester) may be used. In this case, it is possible to reduce an unpleasant feeling of the wearer due to heat which tends to stay inside when the mouth cover 1 is used. In addition, since air resistance toward the front increases when worn by the wearer by laminating the patch 112, it is possible to expect an effect of causing air (exhalation) to flow toward the opening 11.

In addition, as illustrated in FIG. 11A, a double-raschel patch 113 is provided on the rear surface side of the mouth cover body 10 in a location abutting the nose of the wearer. The fitting properties of the mouth cover body 10 with respect to the wearer can be improved using the double-raschel patch 113. Further, since fitting properties, that is, adhesive properties are improved, outbreathing of the wearer can be prevented from leaking to the upper end side.

(5) Regarding the cloth 13 in the foregoing Embodiment 1, as illustrated in the side view of FIG. 11B, the cloth 13 may be stretched to a portion around the lower end of the opening 11 on the front side of the wearer. Due to the presence of this structure, a stretched portion of the cloth 13 is formed as a peak, and therefore it can be biased such that exhalation of the wearer flows out downward.

(6) In the foregoing embodiments, the shape retention member may form a surface in a complex combination of wires or lines such as resin bones. In addition, a function of curbing diffusion of droplets may be imparted by partially changing the mesh of a net of a shape retention member formed of a thermoplastic elastomer, a resin, or the like, and therefore another cloth 13 may not be provided as the mouth cover body 10. That is, a structure in which diffusion of droplets may be prevented with a fine mesh of the net for the portion directly facing the mouth of the wearer and air permeability is improved and breathing is facilitated with a coarse mesh of the net for other portions may be embodied.

(7) The shapes of the notches are not limited to the shapes described in the foregoing embodiments and any of a V-shape, a U-shape, and a circular shape may be adopted. In addition, as described above, the end portion of the mouth cover body 10 can have a discontinuous rigidity by providing notches. However, in a viewpoint of realizing discontinuity in rigidity, it can also be embodied with a combination of different materials, for example, by sandwiching a low-rigidity material therebetween. Namely, it is possible to expect that this low-rigidity material portion will perform a function similar to that of the notches by preparing a mouth cover in which a low-rigidity material is sandwiched between high-rigidity materials. In that case, the notches may be provided or may not be provided.

(8) The opening 11 of the mouth cover described in the foregoing embodiments may be constituted to be able to be opened and closed. That is, the mouth cover 1 may be a mouth cover which can be used in two states, such as a mouth cover in a state in which the opening 11 is blocked and airtightness is high and a mouth cover in a state in which the opening 11 is opened and airtightness is lower than that when it is closed.

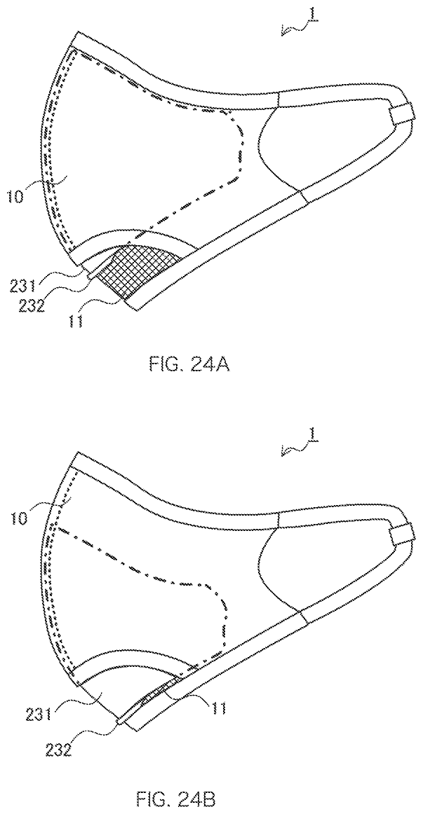

FIGS. 24A and 24B are views illustrating an example in which the opening 11 of the mouth cover is constituted to be able to be opened and closed.

As illustrated in FIGS. 24A and 24B, the mouth cover 1 includes the mouth cover body 10 and an opening cover 231 between the mouth cover body 10 and the mesh fabric. That is, the mouth cover 1 is embodied by a three-layer structure having the mouth cover body 10, the opening cover 231, and the mesh fabric. Further, the opening cover 231 is constituted to be able to slide (slidable) between the mouth cover 1 and the mesh fabric. In FIGS. 24A and 24B, the one-dot dashed line indicates the shape of the opening cover 231, and the mouth cover 1 is bilaterally symmetrical when viewed from the front. In addition, the dotted line in the diagrams indicates the position of the mesh fabric in a portion of the bridge of the nose in the mouth cover. Since the mesh fabric and the mouth cover body 10 are stitched at only the end portion, the opening cover 231 can have a structure in which it can move (slidable).

FIG. 24A illustrates a state in which the opening 11 is exposed, that is, a state in which the opening 11 is open. Meanwhile, FIG. 24B illustrates a state in which the opening 11 is closed by the opening cover 231. In the mouth cover 1, the opening cover 231 is slidable between the state illustrated in FIG. 24A and the state illustrated in FIG. 24B.

In addition, the opening cover 231 may include a grip portion 232 gripped (pinched) by the wearer such that the wearer can easily perform sliding thereof. The grip portion 232 may have any shape as long as it can be gripped by the wearer and sliding of the opening cover 231 is not hindered. As illustrated in FIGS. 24A and 24B, if the grip portion 232 is provided at the lower end of the opening cover 231, it is unlikely to hinder sliding of the opening cover 231. In addition, the opening cover 231 can be prevented from being buried between the mouth cover body 10 and the mesh fabric. In addition, since the opening cover 231 is provided, the mouth cover 1 has a three-layer structure, and it is expected that a function as a filter for preventing diffusion of droplets or the like in portions other than the opening 11 will be improved. In FIGS. 24A and 24B, the opening cover 231 is constituted to straddle substantially the entire region of the mouth cover body 10. However, there is no need for the opening cover 231 to have this size, and it need only have a size to the extent that at least the opening 11 can be completely covered.

In FIGS. 24A and 24B, an example in which the opening cover 231 is provided has been described. However, in this case, the mesh fabric itself of the opening 11 may be constituted to be slidable with respect to the mouth cover body 10. That is, the opening 11 may be constituted to be completely opened in response to sliding of the mesh fabric by providing a sliding portion holding both ends of the mesh fabric in a slidable manner on the rear side of the mouth cover body 10.

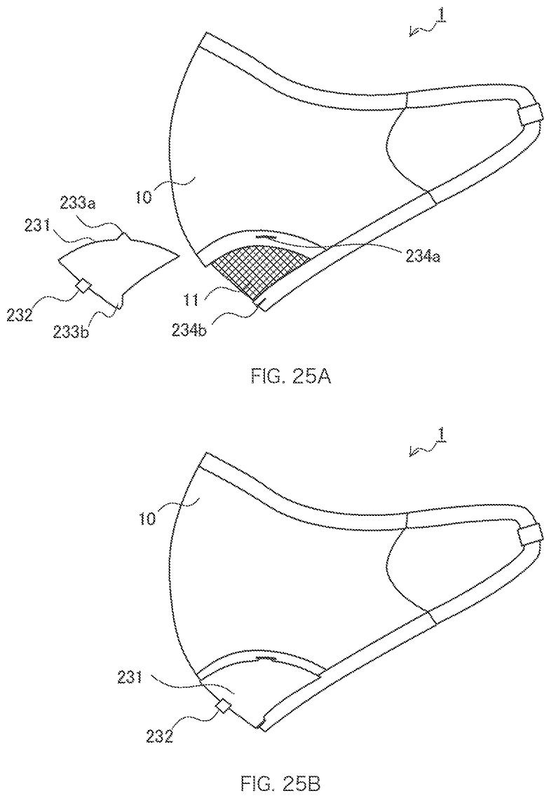

In addition, the constitution of the opening 11 being able to be opened and closed is not limited to the example of FIGS. 24A and 24B. FIGS. 25A and 25B are views illustrating another example of a constitution having the opening 11 of the mouth cover 1 being able to be opened and closed. As illustrated in FIGS. 25A and 25B, a constitution being able to be opened and closed by attachment may be adopted. FIG. 25A illustrates an example in which the opening cover 231 for attachment is constituted to be attachable and detachable with respect to the opening 11 and a state of being detached from the mouth cover 1.

As illustrated in FIG. 25A, the mouth cover body 10 includes slits 234a and 234b for attaching the opening cover 231. The number and the shapes of slits are not limited to those illustrated in the diagrams, and the slits need only allow the opening cover 231 to be attached.

Further, FIG. 25B illustrates a state in which the opening cover 231 is attached to the mouth cover 1, and the opening 11 is in a closed state. As illustrated in FIG. 25A, since a projection portion 233a provided in the opening cover 231 is fitted to the slit 234a and a projection portion 233b is fitted to the slit 234b, the opening cover 231 can be attached to the mouth cover 1, and the opening cover 231 can be unlikely to be detached from the mouth cover 1. In this manner, since the opening cover 231 is made attachable, it becomes easier for the wearer to breathe than the case of illustrated in FIGS. 24A and 24B.

Even with such a form, the opening 11 can be constituted to be able to be opened and closed. Due to such a constitution, the opening 11 can be in a closed state at a place where higher airtightness is required for the mouth cover, and the opening 11 can be in an open state at a place where such high airtightness is not required. Therefore, breathing of the wearer can be prevented as much as possible from being hindered while the mouth cover 1 is worn. In addition, FIGS. 24A and 24B illustrate an example in which the opening cover 231 is attached from above the opening 11. However, a constitution in which an additional opening cover having the same size as the cover body or a size capable of completely covering at least the opening is inserted in an attachable/detachable manner between the mouth cover body (outer fabric) and the mesh (lining fabric) (switchable between a three-layer structure and a two-layer structure) may be employed. At this time, as an example, insertion of an additional opening cover may be performed through an insertion port provided at the upper end of the mouth cover body 10 or may be performed from the gap between the mesh fabric of the opening 11 and the mouth cover body 10.

(9) A deviation prevention member for curbing deviation of the worn the mouth cover occurring due to vibration, wind, or the like when the wearer is wearing the mouth cover may be provided in the mouth cover described in the foregoing embodiments.

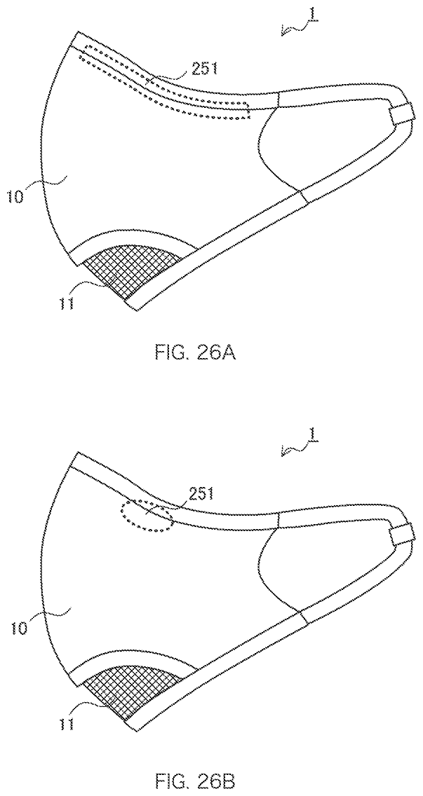

That is, as illustrated in FIGS. 26A and 26B, the mouth cover 1 includes deviation prevention members 251 which come into contact with the skin of the wearer and prevent deviation in the vertical direction on the inward side of the mouth cover 1, that is, a side where the mouth cover 1 comes into contact with the wearer. The deviation prevention members 251 may be any members as long as they have a frictional coefficient equal to or greater than a certain extent in order to come into contact with a human body and prevent deviation of the mouth cover. However, naturally, it is preferable to embody the deviation prevention members 251 using a material which is harmless to a human body and does not give an unpleasant feeling to the wearer at the time of contact. As an example, it is conceivable to use a foam body (sponge) of a urethane resin, a silicone rubber, or the like, but it is not limited thereto.

In addition, as illustrated in FIGS. 26A and 26B, it is desired that the deviation prevention members 251 be provided at positions abutting the upper ends of the cheeks of the wearer, but the positions are not limited to these positions. It is possible to improve the degree of adhesion of the upper end portion of the mouth cover 1 with respect to the wearer and reduce a likelihood of leakage of exhalation of the wearer from the upper end portion of the mouth cover 1 by providing the deviation prevention members 251 at positions abutting the upper ends of the cheeks of the wearer.

(10) Regarding the mouth cover described in the foregoing embodiments in summary, the mouth cover according to the aspect of the present disclosure includes a mouth cover body that covers at least the mouth and the nostrils, and wearing portions that are connected to the mouth cover body and allow a wearer to wear the mouth cover body. The mouth cover body may include an opening in a downward direction from a position directly facing the mouth. Accordingly, it is possible to inhibit diffusion of droplets or the like from the mouth of the wearer, and it is possible to facilitate breathing of the wearer.

In addition, in the foregoing mouth cover, the opening may be constituted at a position where exhalation of the wearer is expelled from the mouth of the wearer to a lower side of the mouth cover body. Accordingly, it is possible to provide a mouth cover having a structure in which droplets or the like are less likely to be confirmed from the mouth of the wearer.

In addition, in the foregoing mouth cover, the mouth cover body may be constituted of an upper portion covering the nose, a middle portion covering the mouth and the nostrils, and a lower portion covering the chin. The opening may be provided in the lower portion. Accordingly, it is possible to identify a position where the opening is provided in the mouth cover.

In addition, in the foregoing mouth cover, the mouth cover body may be formed of a shape retention member allowing the mouth cover body to maintain a predetermined shape. Accordingly, it is possible to maintain the shape of the mouth cover, and it is possible to enhance easiness of breathing by making a space between the mouth cover body and the wearer.

In addition, in the foregoing mouth cover, the shape retention member may be formed of at least a recycled felt material. Accordingly, it is possible to provide an ecological mouth cover.

In addition, in the foregoing mouth cover, further, the shape retention member may be formed of a thermoplastic resin or a thermosetting resin. In addition, in the foregoing mouth cover, the mouth cover body may be formed of a shape retention member and may be constituted of a frame portion constituting window portions in the cheek portions, and a mesh fabric joined to the shape retention member such that at least the window portions are covered. It is possible to enhance easiness of breathing through the mesh fabric by providing the window portions and joining the mesh fabric thereto, and it is possible to prevent diffusion of droplets or the like due to the mesh fabric.

In addition, in the foregoing mouth cover, the mouth cover body may include at least two window portions to which the mesh fabric is joined in the cheek portions. In addition, in the foregoing mouth cover, a cover in which only a portion is joined may be provided in the window portions. Due to the presence of this cover, since a blocked state and an unblocked state of the window portions can be made at the time of inhalation and at the time of exhalation and a constant flow of air can be obtained at the time of inhalation and at the time of exhalation, it is possible to enhance easiness of breathing.

In addition, in the foregoing mouth cover, in the mouth cover body, the shape retention member may be formed of a thermoplastic resin or a thermosetting resin and may be constituted of a wire frame formed to cover at least the mouth and the nostrils, and a cloth joined such that at least an outer circumferential portion of the wire frame is covered. Accordingly, it is possible to provide a mouth cover of which the shape is unlikely to collapse.

In addition, in the foregoing mouth cover, the thermoplastic resin may be a polyester-based elastomer. In addition, in the foregoing mouth cover, the wearing portions may be constituted of string members to be hung on the ears of the wearer at end portions of the mouth cover body in the lateral direction. Accordingly, it is possible to adhere the mouth cover to the wearer, and it is possible to cause the mouth cover to be unlikely to be detached from the face of the wearer.

In addition, in the foregoing mouth cover, the wearing portions may be constituted of string members of which end portions are respectively connected to both end portions of the mouth cover body in the lateral direction. The string members each may include an adjustment member for adjusting a length thereof. Accordingly, it is possible to provide a mouth cover which can be adhered to the face of the wearer with any shape and size of the head.

In addition, in the foregoing mouth cover, the mouth cover body may include notches in an upper end portion of the mouth cover body at positions abutting the nasofacial angle portions of the wearer. Accordingly, it is possible to provide a mouth cover in which a gap is unlikely to be formed between the face of the wearer and the mouth cover.

In addition, in the foregoing mouth cover, the mouth cover body may include notches in end portions of the mouth cover body in the lateral direction. In addition, in the foregoing mouth cover, the mouth cover body may include notches in an upper end portion of the mouth cover body at a position corresponding to lower portions of the outer corners of the eyes of the wearer. In addition, in the foregoing mouth cover, the opening may include a vent portion. Accordingly, it is possible to provide a mouth cover in which a gap is unlikely to be formed between the face of the wearer and the mouth cover by providing notches at locations where a gap is normally likely to be generated between the mask and the wearer.

In addition, in the foregoing mouth cover, when the mouth cover body is regarded to be in one plane, the shape retention member may be a band-shaped member extending in at least any one direction of upward, downward, leftward, rightward, and oblique directions with respect to the plane.

Accordingly, the rigidity and the elasticity of the mouth cover can be improved by simply providing a member having a band shape in the mouth cover as a shape retention member. As a result, since the shape as the mouth cover is easily maintained, the space between the wearer and the mouth cover is easily secured. As a result, the mouth cover becomes a mouth cover with which the wearer easily breathe.

In addition, in the foregoing mouth cover, the band-shaped member may be provided from the upper end portion of the mouth cover body abutting a portion in the vicinity of the base of the nose to the lower end portion of the mouth cover body abutting a portion in the vicinity of the chin. In addition, alternatively, the band-shaped member may suspend the opening. In addition, alternatively, the band-shaped member may be provided at the upper end edge of the mouth cover body. In addition, alternatively, the band-shaped member may be provided at the lower end edge of the mouth cover body. In addition, alternatively, the band-shaped member may be provided at the edge of the opening. In addition, alternatively, the band-shaped member may be provided in a manner of passing through a position abutting a portion in the vicinity of the apex of the nose from the right end to the left end of the mouth cover body. In addition, alternatively, the band-shaped member may be provided in a manner of passing through a position abutting a portion in the vicinity of the apex of the nose from the right lower end to the left lower end of the mouth cover body. In addition, alternatively, the band-shaped member may be provided all the way to the lower end portion of the mouth cover in a manner of passing through portions in the vicinity of the alae of the nose from the upper end portion of the mouth cover body abutting a portion in the vicinity of the base of the nose.

In this manner, since the band-shaped member is provided in a location which becomes more important for maintaining the shape of the mouth cover 1, the shape of the mouth cover 1 is easily maintained, and therefore it is possible to provide the mouth cover 1 having relatively high rigidity and elasticity.

In addition, in the foregoing mouth cover, deviation prevention members for preventing deviation when it is worn on a human body may be provided on a side abutting the human body. Accordingly, it is possible to reduce a likelihood that the mouth cover will deviate from the wearer wearing it, and it is possible to prevent the wearer from having an unpleasant feeling due to deviation.

In addition, in the foregoing mouth cover, the deviation prevention members may be provided at positions in the mouth cover body abutting the upper ends of the cheeks. Accordingly, it is possible to prevent deviation of the mouth cover, and it is possible to improve a likelihood that exhalation can be prevented from leaking from the upper end side of the mouth cover.

In addition, in the foregoing mouth cover, the opening may be constituted to be able to be opened and closed. Accordingly, for example, it is possible to provide a mouth cover in which the opening is opened during exercise to become a mouth cover with which the wearer easily breathe while wearing the mouth cover and droplets or the like of the wearer is unlikely to diffuse in a sealed space or under an environment in which many people gather.

(11) It should be considered that the embodiments disclosed this time are illustrative and are not restrictive in all respects. The scope of the present disclosure is indicated by the claims instead of the foregoing description, and it is intended to include all the changes within the meaning and the scope equivalent to the claims.

What is claimed is:

1. A mouth cover comprising:
a mouth cover body that covers at least the mouth and the nostrils of a wearer; and
wearing portions that are connected to the mouth cover body and allow the wearer to wear the mouth cover body,
wherein the mouth cover body includes an opening in a downward direction from a position directly facing the mouth of the wearer.

2. The mouth cover according to claim 1, wherein the opening is constituted at a position where exhalation of the wearer is expelled from the mouth of the wearer to a lower side of the mouth cover body.

3. The mouth cover according to claim 1,
wherein the mouth cover body is constituted of an upper portion covering the nose of the wearer, a middle portion covering the mouth and the nostrils of the wearer, and a lower portion covering the chin of the wearer, and
wherein the opening is provided in the lower portion.

4. The mouth cover according to claim 1, wherein the mouth cover body includes a shape retention member allowing the mouth cover body to maintain a predetermined shape.

5. The mouth cover according to claim 4, wherein, further, the shape retention member is formed of a thermoplastic resin or a thermosetting resin.

6. The mouth cover according to claim 4, wherein in the mouth cover body, the shape retention member is formed of a thermoplastic resin or a thermosetting resin and is constituted of a wire frame formed to cover at least the mouth and the nostrils of the wearer and a cloth joined to cover at least an outer circumferential portion of the wire frame.

7. The mouth cover according to claim 6, wherein thermoplastic resin is a polyester-based elastomer.

8. The mouth cover according to claim 1, wherein the wearing portions are constituted of string members to be hung on the ears of the wearer at end portions of the mouth cover body in a lateral direction.

9. The mouth cover according to claim 1,
wherein the wearing portions are constituted of string members of which end portions are respectively connected to both end portions of the mouth cover body in a lateral direction, and
wherein the string members each include an adjustment member for adjusting a length thereof.

10. The mouth cover according to claim 1, wherein the mouth cover body includes notches in an upper end portion of the mouth cover body at positions abutting the nasofacial angle portions of the wearer.

11. The mouth cover according to claim 1, wherein the mouth cover body includes notches in end portions of the mouth cover body in a lateral direction.

12. The mouth cover according to claim 1, wherein the mouth cover body includes notches in an upper end portion of the mouth cover body at a position corresponding to lower portions of the outer corners of the eyes of the wearer.

13. The mouth cover according to claim 1, wherein the opening includes a vent portion.

14. The mouth cover according to claim 4, wherein when the mouth cover body is regarded to be in one plane, the shape retention member is a band-shaped member extending in at least any one direction of upward, downward, leftward, rightward, and oblique directions with respect to the plane.

15. The mouth cover according to claim 14, wherein the band-shaped member is provided from an upper end portion of the mouth cover body abutting a portion in the vicinity of the base of the nose of the wearer to a lower end portion of the mouth cover body abutting a portion in the vicinity of the chin of the wearer.

16. The mouth cover according to claim 14, wherein the band-shaped member is provided in a manner of passing through a position abutting a portion in the vicinity of the apex of the nose of the wearer from a right end to a left end of the mouth cover body.

17. The mouth cover according to claim 1, wherein the opening is constituted to be able to be opened and closed.
